(19) United States
(12) Patent Application Publication
(10) Pub. No.: US 2025/0193920 A1
(43) Pub. Date: Jun. 12, 2025

(54) WIRELESS APPARATUS

(71) Applicant: NIPPON TELEGRAPH AND TELEPHONE CORPORATION, Tokyo (JP)

(72) Inventors: Hanae OTANI, Musashino-shi (JP); Kengo NAGATA, Musashino-shi (JP); Akira KISHIDA, Musashino-shi (JP); Shoko SHINOHARA, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/840,959

(22) PCT Filed: Feb. 28, 2022
(86) PCT No.: PCT/JP2022/008241

§ 371 Date: Aug. 23, 2024

(51) Int. Cl. H04W 72/56; H04W 28/08; H04W 48/18

(52) U.S. Cl. CPC H04W 72/56; H04W 28/0975; H04W 48/18

(57) ABSTRACT

A wireless apparatus according to an aspect of the present invention includes an acquisition unit that acquires an index contributing to selection of a link for transmitting a high priority frame among a plurality of links forming multiple links with another wireless apparatus, and a notification unit that notifies the other wireless apparatus of information for selection of the link on the basis of the index.

### CROSS-REFERENCE TO RELATED APPLICATION

The present application is a national stage application, pursuant to 35 U.S.C. § 371, of International Patent Application No. PCT/JP2022/008241, filed Feb. 28, 2022, the entire contents of which are incorporated herein by reference.

### TECHNICAL FIELD

The present invention relates to wireless communication.

### BACKGROUND ART

A wireless local area network (LAN) is known as a wireless system that wirelessly connects an access point and a terminal. The access point and the terminal as wireless stations of the wireless LAN perform carrier sensing based on carrier sense multiple access with collision avoidance (CSMA/CA), and transmit data when a transmission right is acquired.

A multi-link operation under consideration in IEEE 802.11be being formulated as a successor standard to IEEE 802.11ax enables the terminal to establish a plurality of links with the access point. In the case where a plurality of links is established, the wireless station performs carrier sensing based on CSMA/CA for each link, and transmits a data frame, using the link for which the transmission right has been acquired. The multi-link operation provides improved throughput and delay characteristics.

In a case where a high priority frame having a high priority and a low priority frame having a low priority exist in data frames transmitted by the access point or the terminal, when a link having many conflicts is selected as a link for transmitting the high priority frame, delay of the high priority frame is likely to increase. On the other hand, in a case where it is desired to transmit a low priority frame, if a link on which a high priority frame has already been transmitted is selected, transmission of the high priority frame is likely to be affected. As described above, when data frames having different priorities are mixed, performing transmission without performing appropriate link selection according to the priority of the transmission frame deteriorates communication characteristics of multi-link communication.

### CITATION LIST

### Non Patent Literature

Non Patent Literature 1: IEEE P802.11be/D1.2, “35.3.6 Link management”, September 2021.

### SUMMARY OF INVENTION

### Technical Problem

An object of the present invention is to provide a technique for preventing deterioration of communication characteristics of multi-link communication.

### Solution to Problem

A wireless apparatus according to an aspect of the present invention includes an acquisition unit that acquires an index contributing to selection of a link for transmitting a high priority frame among a plurality of links forming multiple links with another wireless apparatus, and a notification unit that notifies the other wireless apparatus of information for selection of the link on the basis of the index.

### Advantageous Effects of Invention

According to the present invention, there is provided a technique for preventing deterioration of communication characteristics of multi-link operation.

### BRIEF DESCRIPTION OF DRAWINGS

FIG. 1 is a diagram illustrating a communication system according to an embodiment.

FIG. 2 is a conceptual diagram illustrating frequency bands used in wireless communication according to the embodiment.

FIG. 3 is a diagram illustrating link management information according to the embodiment.

FIG. 4 is a block diagram illustrating a hardware configuration of an access point according to the embodiment.

FIG. 5 is a block diagram illustrating a functional configuration of the access point according to the embodiment.

FIG. 6 is a diagram illustrating a channel access function of a link management unit according to the embodiment.

FIG. 7 is a block diagram illustrating a hardware configuration of a terminal according to the embodiment.

FIG. 8 is a block diagram illustrating a functional configuration of the terminal according to the embodiment.

FIG. 9 is a flowchart illustrating multi-link setup processing according to the embodiment.

FIG. 10 is a flowchart schematically illustrating an example of multi-link selection executed by the terminal.

FIG. 11 is a flowchart schematically illustrating an example of multi-link selection executed by the access point.

FIG. 12 is a diagram illustrating an example of entering information of a high priority frame in a beacon.

FIG. 13 is a flowchart schematically illustrating Modification 1 of the multi-link selection executed by the terminal.

FIG. 14 is a flowchart schematically illustrating Modification 1 of the multi-link selection executed by the access point.

FIG. 15 is a diagram illustrating one example of a frame format of a trigger frame.

FIG. 16 is a diagram illustrating one example of a table illustrating the relationship between delay time and rank.

FIG. 17 is a flowchart schematically illustrating Modification 2 of the multi-link selection executed by the terminal.

FIG. 18 is a flowchart schematically illustrating Modification 2 of the multi-link selection executed by the access point.

### DESCRIPTION OF EMBODIMENTS

Hereinafter, an embodiment of the present invention is described with reference to the drawings.

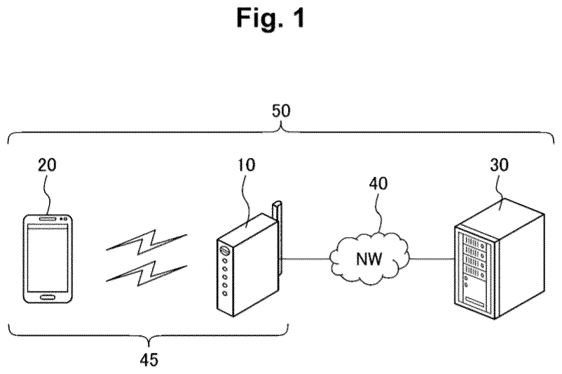

FIG. 1 schematically illustrates a configuration example of a communication system 50 including a wireless network 45 according to the embodiment. The “system” and “network” described in the present specification may be used interchangeably. As illustrated in FIG. 1, the communication system 50 includes an access point 10, a terminal 20, and a server 30. The access point 10 and the terminal 20 are included in the wireless network 45.

The access point 10 operates as an access point (AP) of a wireless LAN. The access point 10 can be wirelessly connected to one or a plurality of terminals. The number of terminals wirelessly connected to the access point 10 dynamically changes. In the example illustrated in FIG. 1, the access point 10 is wirelessly connected to the terminal 20. The access point 10 establishes one or a plurality of links with the terminal 20, and wirelessly communicates with the terminal 20 by using the one or the plurality of links. In the present specification, wireless connection using multiple links between the access point and the terminal is referred to as “multi-link”. The access point 10 is connected to a communication network 40, which may include the Internet, by wire, for example.

The terminal 20 is a wireless terminal apparatus having a wireless communication function. Examples of the wireless terminal apparatus include smart phones, mobile phones, tablet personal computers (PCs), desktop PCs, laptop PCs, Internet of things (IoT) sensors/devices. The terminal 20 exchanges data with a computer such as the server 30 on the communication network 40 via the access point 10.

The server 30 is connected to the communication network 40. For example, the server 30 may be a service provider that provides a service such as a network game, and exchanges data related to the service with the terminal 20 via the communication network 40.

In the wireless network 45, the wireless communication between the access point 10 and the terminal 20 is based on the IEEE 802.11 standard. Note that although the wireless communication based on the IEEE 802.11 standard is described as an example in the present specification, a wireless communication standard different from the IEEE 802.11 standard may be used.

The IEEE 802.11 standard defines a first layer and a media access control (MAC) sublayer as a second layer of an open systems interconnection (OSI) model. In the OSI model, a communication function is divided into seven layers (first layer: physical layer, second layer: data link layer, third layer: network layer, fourth layer: transport layer, fifth layer: session layer, sixth layer: presentation layer, and seventh layer: application layer). The data link layer includes, for example, a logical link control (LLC) layer and a MAC layer. The LLC layer adds a destination service access point (DSAP) header, a source service access point (SSAP) header, and the like to data input from a higher-level layer to generate an LLC packet, for example. The MAC layer adds a MAC header to the LLC packet to generate a MAC frame, for example. The physical layer adds a preamble, a physical layer (PHY) header, and the like to the MAC frame to generate a wireless frame, for example. Here, processing for the first layer and the MAC sublayer as the second layer defined by the IEEE 802.11 standard will be mainly described, and description of processing for other layers is omitted.

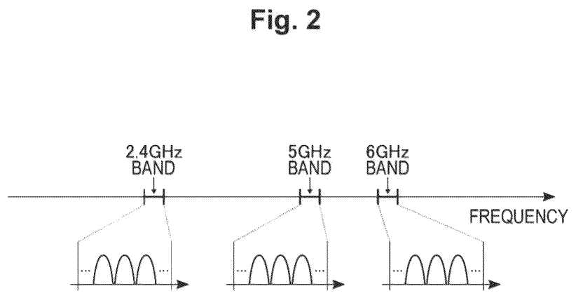

FIG. 2 schematically illustrates frequency bands used in the wireless network 45. In the example illustrated in FIG. 2, three frequency bands of a 6 GHz band, a 5 GHz band, and a 2.4 GHz band are available in the wireless communication between the access point 10 and the terminal 20. Each frequency band includes a plurality of channels. In the present embodiment, a multi-link is formed by using channels of different frequency bands. For example, three links using a channel of the 6 GHz band, a channel of the 5 GHz band, and a channel of the 2.4 GHz band may be established between the access point 10 and the terminal 20. In other embodiments, a plurality of channels included in the same frequency band may be used to form a multi-link.

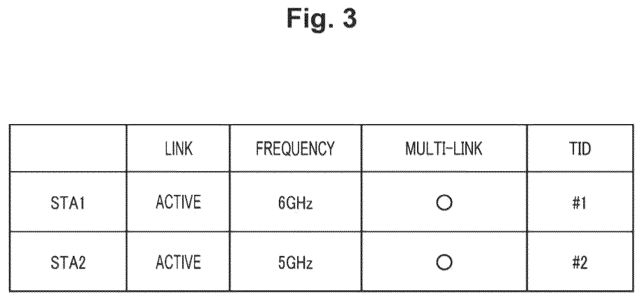

FIG. 3 schematically illustrates a link management table as link management information held by the access point 10. Link management information is information for managing the state of each link. In the example illustrated in FIG. 3, the link management table includes information regarding an STA function, multi-link information, link information, and a traffic identifier (TID).

The STA function corresponds to a wireless signal processing unit that processes a wireless signal. FIG. 3 illustrates, for example, the STA function when the access point 10 includes two wireless signal processing units. For example, STA1 represents the wireless signal processing unit that uses the channel of the 6 GHz band, and STA2 represents the wireless signal processing unit that uses the channel of the 5 GHz band. Note that when the access point 10 includes three or more wireless signal processing units, information of the STA function for each unit is recorded.

The multi-link information includes information indicating whether a multi-link is established between the access point 10 and the terminal, and information indicating which STA is used to establish the link in the case where the multi-link is established. In the example of FIG. 3, “o” is added to the multi-link information regarding the STA function for which multi-link is established. The link information includes information indicating whether a link is used for data transmission. In the example of FIG. 3, “active” is added to the link used for data transmission. That is, the multi-link information illustrated in FIG. 3 indicates that a link is established for each of STA1 and STA2. The link information illustrated in FIG. 3 indicates that the link corresponding to each of STA1 and STA2 is used for data transmission. In other words, links corresponding to STA1 and STA2 are in an active state.

The TID is an identifier indicating a type of traffic (data). Each of the STA functions transmits and receives traffic of the TID allocated thereto. The traffic is classified into a plurality of access categories. In the access category, a priority of data transmission is set. In one example, the traffic may be classified into four access categories of “voice (VO)”, “video (VI)”, “best effort (BE)”, and “background (BK)”. In another example, the traffic may be classified into five access categories of “VO”, “VI”, “BE”, “BK”, and “low latency (LL)”. Traffic of the access category “LL” is latency-sensitive traffic, such as traffic originating from a real-time application such as a network game. For example, traffic of TID #1 is classified into an access category “VO”, and traffic of TID #2 is classified into an access category “VI”. In the example illustrated in FIG. 3, TID #1 is allocated to STA1, and TID #2 is allocated to STA2. Here, for example, in a case where there are four access categories, the priority is higher in the order of “VO”, “VI”, “BE”, and “BK”. On the other hand, in a case where the number of access categories is five, the priority is higher in the order of “LL”, “VO”, “VI”, “BE”, and “BK”. Hereinafter, a wireless frame used for data transmission with a relatively high priority is referred to as a high priority frame. For example, the high priority frame in a case where the number of access categories is five is a wireless frame used for data transmission of the access category “LL”.

The link corresponding to the STA function is associated with a TID when the multi-link between the access point 10 and the terminal is established. For example, in association between a TID and a link (TID-to-link mapping), each TID may be associated with all of links. Alternatively, the association between a TID and a link may be set such that the traffic amount (data amount) becomes equal among the plurality of links forming the multi-link. In addition, traffic of types similar to each other may be associated with a specific link. The frequency band allocated to transmission and reception of traffic is preferably selected in accordance with the type and the data amount of the traffic. For example, it is conceivable that voice (VO) with a small data amount is associated with the 5 GHz band and video (VI) with a large data amount is associated with the 6 GHz band.

Here, when there is a plurality of terminals 20, the associations between the TIDs and the links regarding the terminals 20 establishing a multi-link with the access point 10 may be different from each other. In this case, the access point 10 may have the link management table illustrated in FIG. 3 for each terminal, or may manage the information of the link for each terminal by one link management table.

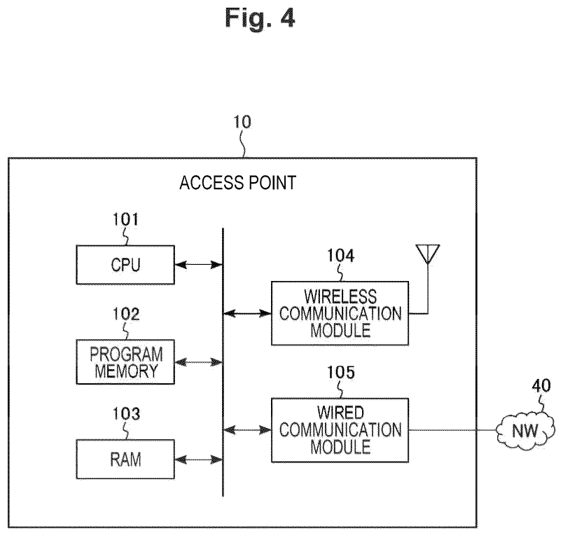

FIG. 4 schematically illustrates a hardware configuration example of the access point 10. As illustrated in FIG. 4, the access point 10 includes, for example, a central processing unit (CPU) 101, a program memory 102, a random access memory (RAM) 103, a wireless communication module 104, and a wired communication module 105.

The CPU 101 is an integrated circuit capable of executing various programs and controls an operation of the entire access point 10. The program memory 102 is a nonvolatile semiconductor memory such as a read only memory (ROM) or a flash memory, and stores a program for controlling the access point 10, control data, and the like. The RAM 103 is, for example, a volatile semiconductor memory, and is used as a working area for the CPU 101. The wireless communication module 104 is a circuit used to transmit and receive data by a wireless signal, and is connected to an antenna. The wireless communication module 104 includes a plurality of communication modules respectively corresponding to a plurality of frequency bands. The wired communication module 105 is a circuit used to transmit and receive data by a wired signal, and is connected to the communication network 40.

The hardware configuration illustrated in FIG. 4 is one example, and the access point 10 may have a hardware configuration different from that illustrated in FIG. 4. For example, in a case where the access point 10 is wirelessly connected to the communication network 40, the wired communication module 105 may be omitted from the access point 10.

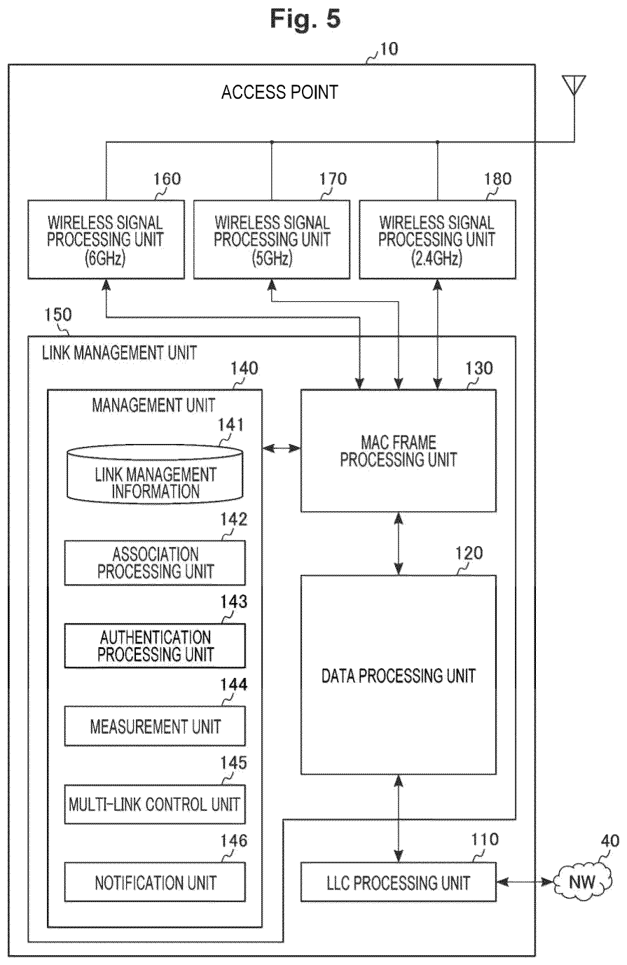

FIG. 5 schematically illustrates a functional configuration example of the access point 10. As illustrated in FIG. 5, the access point 10 includes an LLC processing unit 110, a link management unit 150, and wireless signal processing units 160, 170, and 180. The LLC processing unit 110 can be implemented by a combination of the CPU 101 and the wired communication module 105. A data processing unit 120, a MAC frame processing unit 130, the link management unit 150, and the wireless signal processing units 160, 170, and 180 can be implemented by a combination of the wireless communication module 104 or the wireless communication module 104 and the CPU 101.

The LLC processing unit 110 executes processing of the LLC layer and processing of the higher-level layer (third layer to seventh layer) on input data. For example, the LLC processing unit 110 adds a DSAP header, an SSAP header, and the like to data received from a computer (for example, the server 30 illustrated in FIG. 1) on the communication network 40 to generate an LLC packet, and sends the LLC packet to the link management unit 150. Furthermore, the LLC processing unit 110 receives the LLC packet from the link management unit 150, extracts data from the LLC packet, and transmits the data to the computer on the communication network 40.

The link management unit 150 performs processing of the MAC layer on input data. Further, the link management unit 150 manages the link with each terminal wirelessly connected to the access point 10. The link management unit 150 includes the data processing unit 120, the MAC frame processing unit 130, and a management unit 140.

The data processing unit 120 receives the LLC packet from the LLC processing unit 110, and adds a MAC header to the LLC packet to generate a MAC frame. Then, the data processing unit 120 sends the MAC frame to the MAC frame processing unit 130. In addition, the data processing unit 120 receives the MAC frame from the MAC frame processing unit 130 and extracts the LLC packet from the MAC frame. Then, the data processing unit 120 sends the LLC packet to the LLC processing unit 110.

The MAC frame processing unit 130 receives the MAC frame that is a data frame from the data processing unit 120, and temporarily stores the MAC frame. Then, the MAC frame processing unit 130 performs carrier sensing to confirm the situation of the channel corresponding to the link associated with the TID of the data included in the MAC frame. In a case where the channel is busy, the MAC frame processing unit 130 continues the carrier sensing. In a case where the channel is idle, the MAC frame processing unit 130 sends the MAC frame to the wireless signal processing unit corresponding to the link associated with the TID of the data included in the MAC frame. The MAC frame processing unit 130 receives the MAC frame that is a management frame or a control frame from the management unit 140, and sends the MAC frame to any one of the wireless signal processing units 160, 170, and 180.

Further, the MAC frame processing unit 130 receives the MAC frames from the wireless signal processing units 160, 170, and 180, and sends the MAC frames to the data processing unit 120 or the management unit 140 according to the type of the MAC frames. For example, in a case where the MAC frame is a data frame, the MAC frame processing unit 130 sends the MAC frame to the data processing unit 120. In a case where the MAC frame is a management frame or a control frame, the MAC frame processing unit 130 sends the MAC frame to the management unit 140. Moreover, the MAC frame processing unit 130 executes processing based on an instruction of the management unit 140, and exchanges information with the management unit 140.

The management unit 140 manages the links to the terminals on the basis of information included in the management frames received from the wireless signal processing units 160, 170, and 180 via the MAC frame processing unit 130. In one example, the management unit 140 includes link management information 141, an association processing unit 142, an authentication processing unit 143, a measurement unit 144, a multi-link control unit 145, and a notification unit 146.

The link management information 141 includes information related to terminals wirelessly connected to the access point 10. The link management information 141 is stored in, for example, the RAM 103 and is referred to by the MAC frame processing unit 130. For example, the MAC frame processing unit 130 uses the link management information 141 to identify a link corresponding to a TID of data included in a MAC frame to be transmitted.

The association processing unit 142 executes a protocol related to an association in a case of receiving a connection request from a terminal via any one of the wireless signal processing units 160, 170, and 180. The authentication processing unit 143 executes a protocol related to authentication subsequent to the association.

The measurement unit 144 measures at least one kind of index contributing to selection of a link. Some of the indexes may be statistics.

The at least one type of index to be measured includes a high priority frame rate. The high priority frame rate is the occupancy of the high priority frame in a wireless frame transmitted on each link. The high priority frame rate is represented by, for example, two values of high and low. For example, in a case where the rate of high priority frames in wireless frames transmitted in a certain period for one link is equal to or more than a threshold, the high value is set to the high priority frame rate. On the other hand, in a case where the rate of high priority frames in wireless frames transmitted in a certain period for one link is less than a threshold, the low value is set to the high priority frame rate. The high priority frame rate for a certain link may be expressed as high or low relative to the average value of the high priority frame rates of all links. In this case, in a case where the rate of high priority frames in wireless frames transmitted in a certain period for one link is equal to or greater than the average value of the high priority frame rates of all links, the high value is set to the high priority frame rate for the corresponding link. On the other hand, in a case where the rate of high priority frames in wireless frames transmitted in a certain period for one link is less than the average value of the high priority frame rates of all links, the low value is set to the high priority frame rate for the corresponding link. Furthermore, if necessary, the high priority frame rate may be information of a link associated with a wireless frame defined as a high priority frame in category information of time sensitive network (TSN) over Wi-Fi.

Furthermore, the at least one type of index to be measured may include an average delay time that is an average value of delay times of transmission of the wireless frame for each link. The delay time may be measured from a time such as a queuing time, a contention wait time, a contention time, a retransmission time, or a transmission time. The queuing time is a time from when a MAC frame is input to the end of the transmission queue until the MAC frame arrives at the head of the transmission queue. The contention wait time is a wait time determined by the AIFS for collision avoidance control between access categories. The contention time is a wait time for avoiding transmission collision between a plurality of access categories or between terminals. The retransmission time is an additional time in a case where retransmission is required. The transmission time is a time from transmission of a wireless frame to reception of an acknowledgment (ACK) from the access point. Further, if necessary, in addition to the average delay time, the maximum delay time or the minimum delay time may be measured. Further, ranking may be performed according to the length of the delay time for each link.

In addition, the at least one type of index to be measured may include an arbitrary index that contributes to selection of a link for transmitting a high priority frame.

The multi-link control unit 145 controls the use of a plurality of links forming a multi-link for each terminal. For example, the multi-link control unit 145 selects a link to be used for transmission of a wireless frame according to an index measured by the measurement unit 144. Further, the multi-link control unit 145 executes association between the TIDs and the links. The association between the TIDs and the links is performed when, for example, a multi-link is established between the access point 10 and the terminal 20.

The notification unit 146 notifies the terminal 20 of multi-link control information for controlling the use of the plurality of links forming the multi-link. In one example, the multi-link control information includes information of a high priority frame or a delay time for selecting a link. The multi-link control information may be transmitted to the terminal 20 with a management frame (for example, a beacon). In another example, the multi-link control information may be sent to the terminal 20 in the trigger frame.

The wireless signal processing unit 160 transmits and receives data between the access point 10 and the terminal 20 by wireless communication. Specifically, the wireless signal processing unit 160 executes physical layer processing for the input data or wireless signal. For example, the wireless signal processing unit 160 receives a MAC frame from the MAC frame processing unit 130, and adds a preamble, a PHY header, and the like to the MAC frame to generate a wireless frame. Then, the wireless signal processing unit 160 performs a predetermined modulation operation on the wireless frame to convert the wireless frame into a wireless signal, and radiates the wireless signal via an antenna. The predetermined modulation operation includes convolutional coding, interleaving, subcarrier modulation, inverse fast Fourier transform (IFFT), orthogonal frequency division multiplexing (OFDM) modulation, and frequency transform, for example. Further, the wireless signal processing unit 160 receives a wireless signal from the terminal 20 via the antenna, and performs a predetermined demodulation operation on the received wireless signal to obtain a wireless frame. The predetermined demodulation operation includes frequency transform, OFDM demodulation, fast Fourier transform (FFT), subcarrier demodulation, deinterleaving, and Viterbi decoding, for example. Then, the wireless signal processing unit 160 extracts the MAC frame from the wireless frame, and sends the MAC frame to the MAC frame processing unit 130.

The wireless signal processing units 170 and 180 perform processing similar to the wireless signal processing unit 160. Therefore, description of the wireless signal processing units 170 and 180 is omitted. In the present example, the wireless signal processing units 160, 170, and 180 handle the wireless signals of the 6 GHz band, the 5 GHz band, and the 2.4 GHz band, respectively. Note that the wireless signal processing units 160, 170, and 180 may use a common antenna or may use individual antennas.

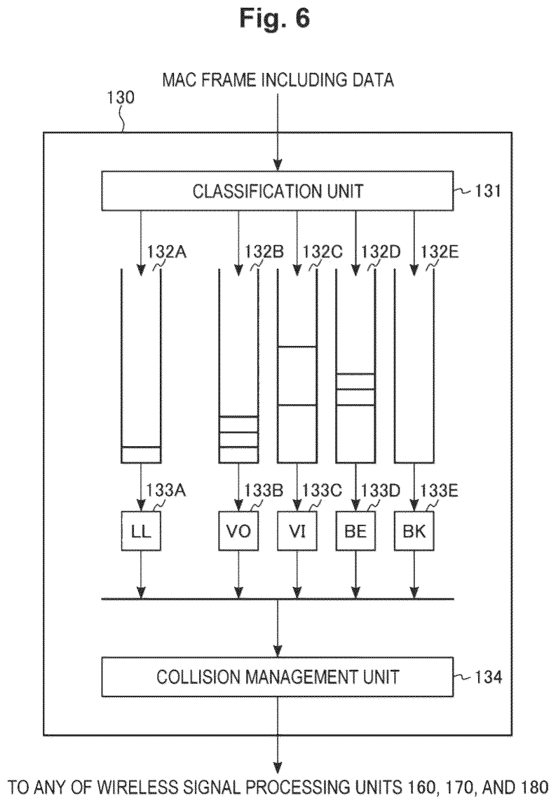

FIG. 6 schematically illustrates a channel access function of the MAC frame processing unit 130. As illustrated in FIG. 6, the MAC frame processing unit 130 includes a classification unit 131, transmission queues 132A, 132B, 132C, 132D, and 132E, carrier sensing execution units 133A, 133B, 133C, 133D, and 133E, and a collision management unit 134.

The classification unit 131 classifies the MAC frames received from the data processing unit 120 and inputs the MAC frames to the transmission queues 132A, 132B, 132C, 132D, and 132E. In the example illustrated in FIG. 6, the classification unit 131 classifies the MAC frames into five access categories “LL”, “VO”, “VI”, “BE”, and “BK”, inputs the MAC frame classified into the access category “LL” to the transmission queue 132A, inputs the MAC frame classified into the access category “VO” to the transmission queue 132B, inputs the MAC frame classified into the access category “VI” to the transmission queue 132C, inputs the MAC frame classified into the access category “BE” to the transmission queue 132D, and inputs the MAC frame classified into the access category “BK” to the transmission queue 132E. The transmission queues 132A, 132B, 132C, 132D, and 132E buffer the input MAC frames. The transmission queues 132A, 132B, 132C, 132D, and 132E are implemented by, for example, the RAM 103.

The carrier sensing execution units 133A, 133B, 133C, 133D, and 133E execute carrier sensing based on CSMA/CA according to access parameters set in advance for the respective units. The access parameter is set for each access category such that transmission of wireless signals is prioritized in the order of “LL”, “VO”, “VI”, “BE”, and “BK”, for example. The carrier sensing execution units 133A, 133B, 133C, 133D, and 133E execute carrier sensing for the MAC frames stored in the transmission queues 132A, 132B, 132C, 132D, and 132E, respectively. For example, in a case where the transmission right is acquired (in a case where the channel is idle), the carrier sensing execution unit 133A extracts the MAC frame from the transmission queue 132A and outputs the MAC frame to the wireless signal processing unit corresponding to the link associated with the access category “LL” via the collision management unit 134.

The collision management unit 134 prevents a transmission collision in a case where a plurality of carrier sensing execution units among the carrier sensing execution units 133A, 133B, 133C, 133D, and 133E acquires the transmission right for the same link. The collision management unit 134 gives priority to transmission of high-priority frame data. Assume that the carrier sensing execution unit 133A and one of the carrier sensing execution units 133B, 133C, 133D, and 133E simultaneously acquire the transmission right for the link corresponding to the wireless signal processing unit 160. In this case, the collision management unit 134 gives priority to the transmission right acquired by the carrier sensing execution unit 133A, and outputs the MAC frame received from the carrier sensing execution unit 133A to the wireless signal processing unit 160.

In the embodiment, an example in which the MAC frame processing unit 130 implements the channel access function is described, but the wireless signal processing units 160, 170, and 180 may implement the channel access function.

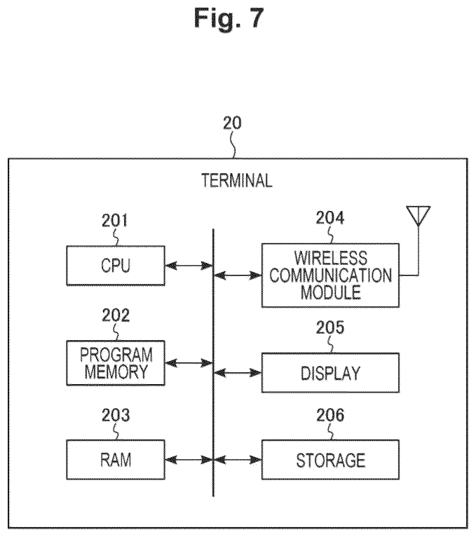

FIG. 7 schematically illustrates a hardware configuration example of the terminal 20. As illustrated in FIG. 7, the terminal 20 includes, for example, a CPU 201, a program memory 202, a RAM 203, a wireless communication module 204, a display 205, and a storage 206.

The CPU 201 is an integrated circuit capable of executing various programs, and controls overall operation of the terminal 20. The program memory 202 is a nonvolatile semiconductor memory such as a ROM, and stores a program for controlling the terminal 20, control data, and the like. The storage 206 may be used as the program memory 202. The RAM 203 is, for example, a volatile semiconductor memory, and is used as a working area for the CPU 201. The wireless communication module 204 is a circuit used to transmit and receive data by a wireless signal and is configured to be connectable to an antenna. Furthermore, the wireless communication module 204 includes, for example, a plurality of communication modules respectively corresponding to a plurality of frequency bands. The display 205 displays information of a graphical user interface (GUI) provided by application software or the like, for example. The display 205 may have a function as an input interface of the terminal 20. For example, a touch panel may be provided on the display 205. The storage 206 is a nonvolatile storage device, and stores data including system software and the like of the terminal 20, for example.

The hardware configuration illustrated in FIG. 7 is one example, and the terminal 20 may have a hardware configuration different from that illustrated in FIG. 7. For example, in a case where the terminal 20 is an IoT device or the like, the display 205 may be omitted from the terminal 20.

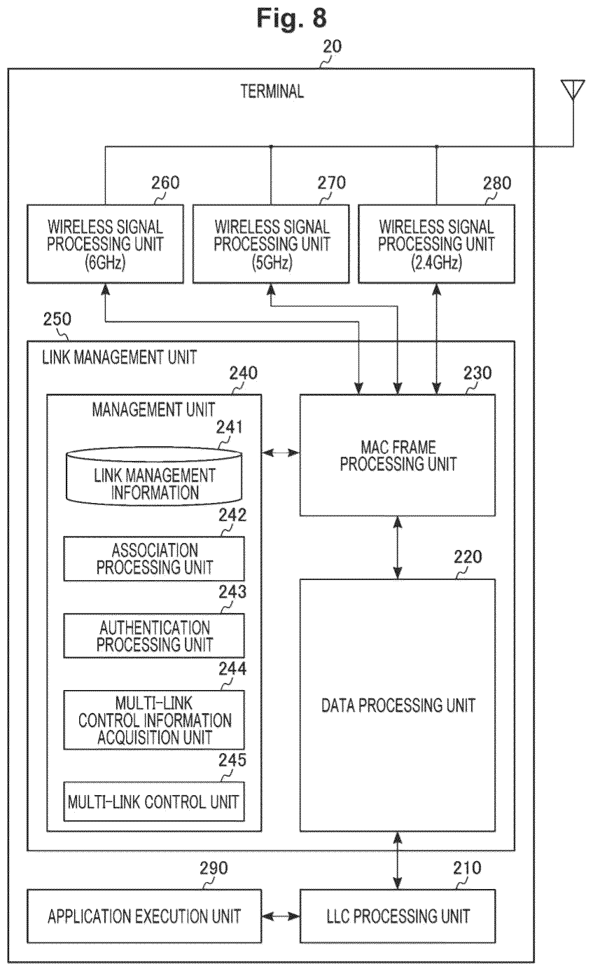

FIG. 8 schematically illustrates a functional configuration example of the terminal 20. As illustrated in FIG. 8, the terminal 20 includes an LLC processing unit 210, a link management unit 250, wireless signal processing units 260, 270, and 280, and an application execution unit 290. The LLC processing unit 210 and the application execution unit 290 can be implemented by the CPU 201. The link management unit 250 and the wireless signal processing units 260, 270, and 280 can be implemented by the wireless communication module 204 or a combination of the wireless communication module 204 and the CPU 201.

The LLC processing unit 210 executes processing of the LLC layer and the higher-level layer for input data. For example, the LLC processing unit 210 receives data from the application execution unit 290, adds the DSAP header, the SSAP header, and the like to the data to generate an LLC packet, and sends the LLC packet to the link management unit 250. In addition, the LLC processing unit 210 receives the LLC packet from the link management unit 250, extracts data from the LLC packet, and sends the data to the application execution unit 290.

The link management unit 250 executes processing of the MAC layer for the input data. Moreover, the link management unit 250 manages the link with the access point 10 wirelessly connected to the terminal 20. The link management unit 250 includes a data processing unit 220, a MAC frame processing unit 230, and a management unit 240.

The data processing unit 220 receives the LLC packet from the LLC processing unit 210, and adds a MAC header to the LLC packet to generate a MAC frame. Then, the data processing unit 220 sends the MAC frame to the MAC frame processing unit 230. In addition, the data processing unit 220 receives the MAC frame from the MAC frame processing unit 230 and extracts the LLC packet from the MAC frame. Then, the data processing unit 220 sends the LLC packet to the LLC processing unit 210.

The MAC frame processing unit 230 receives the MAC frame that is a data frame from the data processing unit 220, and temporarily stores the MAC frame. Then, the MAC frame processing unit 230 performs carrier sensing to confirm the situation of the channel corresponding to the link associated with the TID of data included in the MAC frame. In a case where the channel is busy, the MAC frame processing unit 230 continues the carrier sensing. In a case where the channel is idle, the MAC frame processing unit 230 sends the MAC frame to the wireless signal processing unit corresponding to the link associated with the TID of the data included in the MAC frame. Since the channel access function of the MAC frame processing unit 230 is similar to the channel access function of the MAC frame processing unit 130 of the access point 10 described with reference to FIG. 6, description of the channel access function of the MAC frame processing unit 230 is omitted.

The MAC frame processing unit 230 receives the MAC frame that is a management frame or a control frame from the management unit 240, and sends the MAC frame to any one of the wireless signal processing units 260, 270, and 280.

Further, the MAC frame processing unit 230 receives the MAC frames from the wireless signal processing units 260, 270, and 280, and sends the MAC frames to the data processing unit 220 or the management unit 240 according to the type of the MAC frames. For example, in a case where the MAC frame is a data frame, the MAC frame processing unit 230 sends the MAC frame to the data processing unit 220. In a case where the MAC frame is a management frame or a control frame, the MAC frame processing unit 230 sends the MAC frame to the management unit 240. Moreover, the MAC frame processing unit 230 executes processing based on an instruction of the management unit 240, and exchanges information with the management unit 240.

The management unit 240 manages the links to the access point 10 on the basis of multi-link control information received from the wireless signal processing units 260, 270, and 280 via the MAC frame processing unit 230. The management unit 240 includes link management information 241, an association processing unit 242, an authentication processing unit 243, a multi-link control information acquisition unit 244, and a multi-link control unit 245.

The link management information 241 includes information related to the access point 10 wirelessly connected to the terminal 20. The link management information 241 may include information of the STA function, multi-link, link, and TID. The link management information 241 can match information related to the terminal 20 included in the link management information 141 of the access point 10. The terminal 20 may measure a delay for each link (STA function) and register a measured value of the delay in the link management information 241. The link management information 241 is stored in, for example, the RAM 203 and is referred to by the MAC frame processing unit 230. For example, the MAC frame processing unit 230 uses the link management information 241 to identify a link corresponding to a TID of data included in a MAC frame to be transmitted.

The association processing unit 242 executes a protocol related to an association including transmission of a connection request to the access point 10. The authentication processing unit 243 executes a protocol related to authentication subsequent to the association.

The multi-link control information acquisition unit 244 acquires multi-link control information from the access point 10, and sends the multi-link control information to the multi-link control unit 245. For example, the multi-link control information acquisition unit 244 acquires multi-link control information from a beacon.

The multi-link control unit 245 controls the use of a plurality of links forming a multi-link between the access point 10 and the terminal 20 on the basis of the multi-link control information. Further, the multi-link control unit 245 determines association between the TIDs and the links. The association between the TIDs and the links is executed at predetermined timing such as when a multi-link is established between the access point 10 and the terminal 20. For example, at the time of multi-link setup, the multi-link control unit 245 determines the association between the TIDs and the links, and requests the multi-link control unit 145 of the access point 10 to apply the association. Then, when the terminal 20 receives a positive response to the request from the access point 10, the association between the TIDs and the links is confirmed.

Note that the management unit 240 may further include a measurement unit that performs processing similar to the measurement unit 144 of the access point 10. In a case where the management unit 240 includes a measurement unit, the access point 10 is notified of the measurement result obtained by the measurement unit and the access point 10 uses the measurement result to perform multi-link control.

The wireless signal processing unit 260 transmits and receives data between the access point 10 and the terminal 20 by wireless communication. Specifically, the wireless signal processing unit 260 executes physical layer processing for the input data or wireless signal. For example, the wireless signal processing unit 260 receives a MAC frame from the MAC frame processing unit 230, and adds a preamble, a PHY header, and the like to the MAC frame to generate a wireless frame. Then, the wireless signal processing unit 260 performs a predetermined modulation operation on the wireless frame to convert the wireless frame into a wireless signal, and radiates the wireless signal via an antenna. Furthermore, the wireless signal processing unit 260 receives the wireless signal from the access point 10 via the antenna, and performs a predetermined demodulation operation on the received wireless signal to obtain the wireless frame. Then, the wireless signal processing unit 260 extracts the MAC frame from the wireless frame, and sends the MAC frame to the MAC frame processing unit 230.

The wireless signal processing units 270 and 280 perform processing similar to the wireless signal processing unit 260. Therefore, description of the wireless signal processing units 270 and 280 is omitted. In the present example, the wireless signal processing units 260, 270, and 280 handle the wireless signals of the 6 GHz band, the 5 GHz band, and the 2.4 GHz band, respectively. Note that the wireless signal processing units 260, 270, and 280 may use a common antenna or may use individual antennas.

The application execution unit 290 executes an application using data received from the LLC processing unit 210. The application execution unit 290 sends data to the LLC processing unit 210 or receives data from the LLC processing unit 210 according to the operation of the application. The application execution unit 290 can display information from the application on the display 205. Furthermore, the application execution unit 290 can execute processing according to a user operation on an input interface.

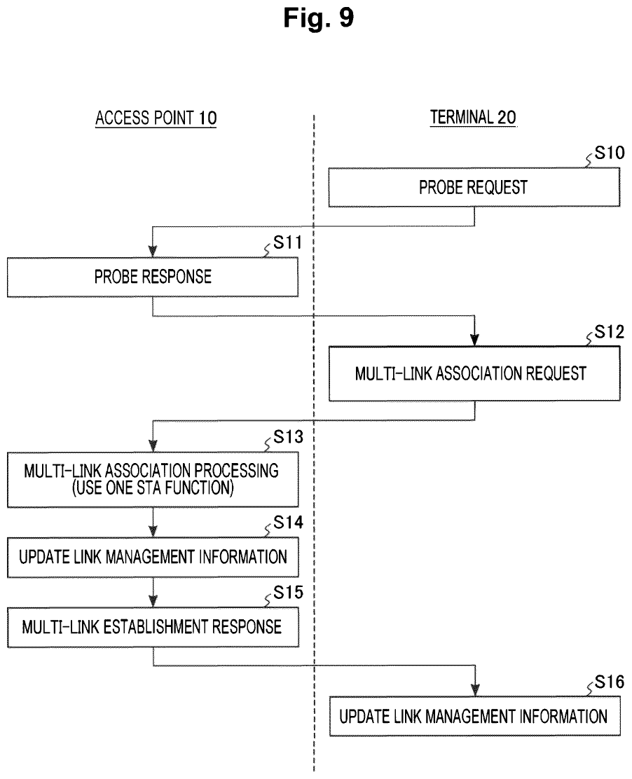

An operation example related to multi-link setup between the access point 10 and the terminal 20 will be described with reference to FIG. 9. The multi-link setup is performed using the management frame.

In step S10, the terminal 20 transmits (broadcasts) a probe request. The probe request is a signal for confirming whether or not an access point exists around the terminal 20. When receiving the probe request from the terminal 20, the access point 10 executes processing of step S11.

In step S11, the access point 10 transmits a probe response to the terminal 20. The probe response is a signal used by the access point 10 to respond to the probe request from the terminal 20. When receiving the probe response from the access point 10, the terminal 20 executes processing of step S12. Here, the probe response includes information necessary for establishing a multi-link.

In step S12, the terminal 20 transmits an association request to the access point 10 via any of the STA functions of the terminal 20. The association request includes a signal for requesting the access point 10 to establish a multi-link. For example, the association request is generated by the management unit 240 of the terminal 20. When receiving the association request including the signal for requesting establishment of a multi-link, the management unit 140 of the access point 10 executes processing of step S13. Note that, as the association request, a normal association request to which information for multi-link connection is added may be used.

In step S13, the management unit 140 of the access point 10 executes multi-link association processing using one STA function. Specifically, first, the access point 10 executes association processing of the first STA function with the terminal 20. Then, when a link is established in the first STA function, the management unit 140 of the access point 10 executes association processing of the second STA function using the first STA function for which the link has been established. That is, the STA function with an established link is used for association processing of the STA function with no established link. When the association processing of at least two STA functions is completed, the access point 10 recognizes that a multi-link with the terminal 20 has been established, and executes processing of step S14.

In step S14, the management unit 140 of the access point 10 updates the link management information 141.

In step S15, the access point 10 transmits a multi-link establishment response to the terminal 20. The multi-link establishment response is a signal used for a response to the multi-link request. When receiving the multi-link establishment response from the access point 10, the management unit 240 of the terminal 20 recognizes that the multi-link with the access point 10 has been established, and executes processing of step S16.

In step S16, the management unit 240 of the terminal 20 updates the link management information 241.

The link management information is updated in both the access point 10 and the terminal 20, whereby the multi-link setup is completed. Thereafter, data communication using the multi-link becomes possible between the access point 10 and the terminal 20.

Here, in the example illustrated in FIG. 9, the connection processing for establishing a multi-link is performed after the probe request from the terminal 20 and the probe response from the access point 10. Alternatively, the access point 10 may periodically transmit a beacon, and the terminal 20 that has received the beacon may transmit an association request for establishing a multi-link, thereby performing the connection processing for establishing a multi-link.

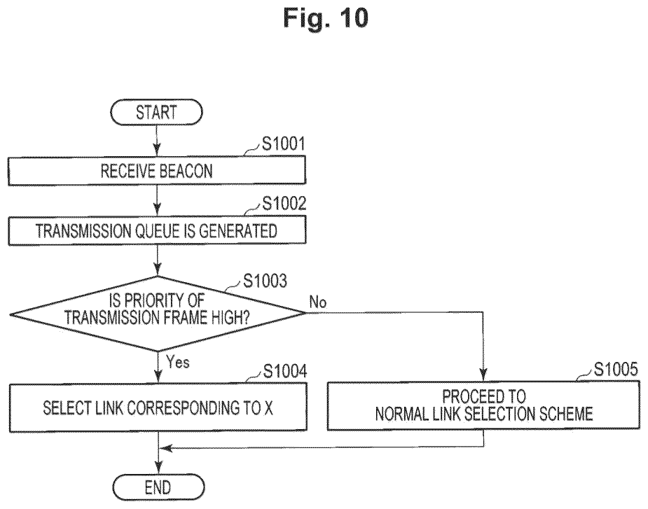

Next, an operation of selecting a link during data transmission will be described. FIG. 10 is a flowchart schematically illustrating an example of multi-link selection executed by the terminal 20. Processing of the flowchart illustrated in FIG. 10 may be started every certain period after the multi-link setup illustrated in FIG. 9 is completed. Note that in the following example, a link is selected from among three links. The links are numbered as “Link 1”, “Link 2”, and “Link 3”. For example, Link 1 is a link by the wireless signal processing unit using the channel of the 6 GHz band, Link 2 is a link by the wireless signal processing unit using the channel of the 5 GHz band, and Link 3 is a link by the wireless signal processing unit using the channel of the 2.4 GHz band.

In step S1001, the multi-link control information acquisition unit 244 receives a beacon from any one of the wireless signal processing units 260, 270, and 280 via the MAC frame processing unit 230. When receiving the beacon, the multi-link control information acquisition unit 244 acquires multi-link control information from the beacon. The multi-link control information acquisition unit 244 sends the multi-link control information to the multi-link control unit 245.

In step S1002, each element of the terminal 20 stands by until a transmission queue is generated. In a case where data to be transmitted to the access point 10 is generated by, for example, processing of an application of the terminal 20, it is determined that a transmission queue is generated. Thereafter, the processing proceeds to step S1003. Note that in a case where the transmission queue is not generated during a certain period, the processing of FIG. 10 may be ended.

In step S1003, the MAC frame processing unit 230 receives a MAC frame as a wireless frame to be transmitted via the LLC processing unit 210 and the data processing unit 220. Meanwhile, the multi-link control unit 245 determines whether or not the priority of the wireless frame to be transmitted is high on the basis of the TID, for example. For example, when the TID indicates “LL”, it is determined that the priority of the wireless frame to be transmitted is high. If it is determined in step S1003 that the priority of the wireless frame to be transmitted is high, the processing proceeds to step S1004. If it is determined in step S1003 that the priority of the wireless frame to be transmitted is not high, the processing proceeds to step S1005. Here, the determination of the priority level in step S1003 is not limited to being performed using the TID. For example, the determination of the priority level may be performed using the priority directly associated with the wireless frame to be transmitted.

In step S1004, the multi-link control unit 245 selects a link associated with “X” as the link for transmitting the wireless frame to be transmitted on the basis of information of the high priority frame of the multi-link control information. Thereafter, the processing in FIG. 10 is ended. “X” indicates the number of a link determined in the access point 10. “X” is information included in multi-link control information. The method of determining “X” will be described in detail later. Note that multi-link control information may include information on a magnitude relationship of the high priority frame rate instead of or in addition to X. In this case, the multi-link control unit 245 may select a link by using the magnitude relationship of the high priority frame rate. For example, the multi-link control unit 245 may select a link having the minimum high priority frame rate.

In step S1005, the multi-link control unit 245 selects a link on the basis of a normal link selection scheme. Thereafter, the processing in FIG. 10 is ended. For example, the multi-link control unit 245 selects a link associated with the TID.

After selecting the link, the multi-link control unit 245 notifies the MAC frame processing unit 230 of information on the selected link. The MAC frame processing unit 230 performs carrier sensing to confirm the situation of a channel corresponding to the notified link, and when the channel is idle, sends a MAC frame to the wireless signal processing unit corresponding to the notified link. As a result, the wireless signal is transmitted.

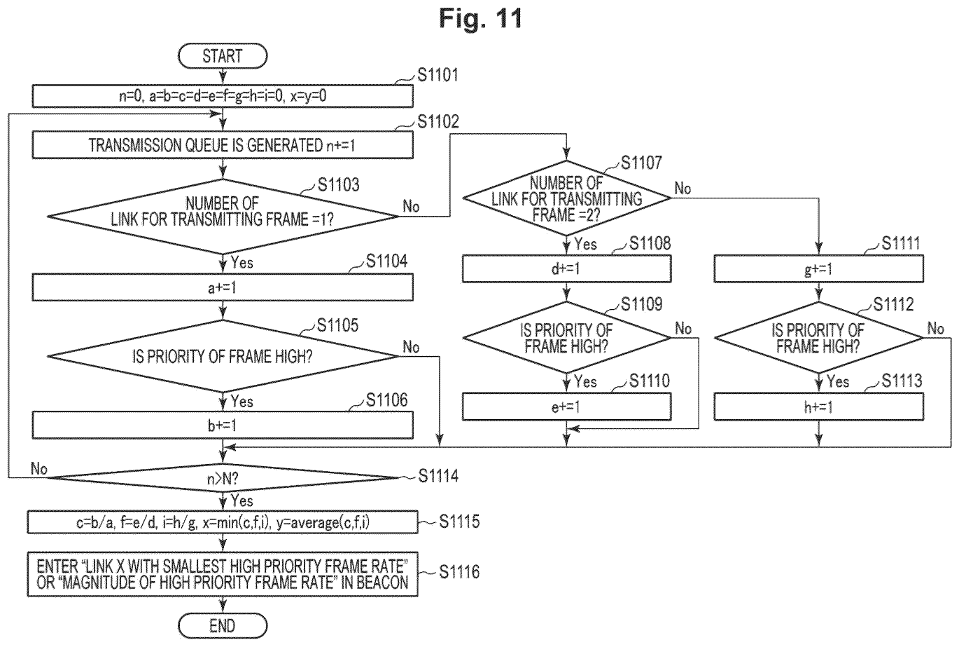

FIG. 11 is a flowchart schematically illustrating an example of multi-link selection executed by the access point 10. Processing of the flowchart illustrated in FIG. 11 may be started every certain period after the multi-link setup illustrated in FIG. 9 is completed.

In step S1101, the multi-link control unit 145 initializes a variable for link selection. The variables include, for example, n, a, b, c, d, e, f, g, h, i, x, and y. n is a count number of the total number of times of generation of a transmission queue. a is a count number of the number of times of generation of a transmission queue of Link 1, d is a count number of the number of times of generation of a transmission queue of Link 2, and g is a count number of the number of times of generation of a transmission queue of Link 3. b is a count number of the number of times a transmission queue with high priority is generated in Link 1, e is a count number of the number of times a transmission queue with high priority is generated in Link 2, and h is a count number of the number of times a transmission queue with high priority is generated in Link 3. c is a value of b/a, that is, the high priority frame rate for Link 1. f is a value of e/d, that is, the high priority frame rate for Link 2. i is a value of h/g, that is, the high priority frame rate for Link 3. x is the minimum value of c, f, and i, that is, the minimum value of the high priority frame rate. y is the average value of c, f, and i, that is, the average value of the high priority frame rates of Links 1, 2, and 3. In step S1101, the multi-link control unit 145 initializes n, a, b, c, d, e, f, g, h, i, x, and y to 0.

In step S1102, each element of the access point 10 stands by until a transmission queue is generated. For example, when a beacon transmission interval arrives, it is determined that a transmission queue is generated. Alternatively, in a case where it is necessary to transmit a wireless frame such as a management frame or a trigger frame, it is determined that a transmission queue is generated. Alternatively, in a case where data to be transmitted from the server 30 to the terminal 20 is generated, it is determined that a transmission queue is generated. When a transmission queue is generated, the multi-link control unit 145 selects a link on the basis of, for example, a TID and link management information. Then, the multi-link control unit 145 notifies the MAC frame processing unit 130 of the information on the selected link. The MAC frame processing unit 130 performs carrier sensing to confirm the situation of a channel corresponding to the notified link, and when the channel is idle, sends a MAC frame to the wireless signal processing unit corresponding to the notified link. As a result, the wireless signal is transmitted. When the wireless frame to be transmitted is a beacon, the beacon is transmitted from the access point 10 to the terminal 20. After completing the transmission of the wireless frame, the multi-link control unit 145 increments n by 1. Thereafter, the processing proceeds to step S1103. Note that in a case where the transmission queue is not generated during a certain period, the processing of FIG. 11 may be ended. In a case where the processing in FIG. 11 is started again, the processing may be performed from the initialization of the variable in step S1101, or the processing may be performed from waiting for generation of a transmission queue in step S1102. In addition, in step S1102, it may be determined that a transmission queue is generated also in a case where a transmission queue is generated in the terminal 20, that is, in a case where a wireless frame has been transmitted from the terminal 20.

In step S1103, the multi-link control unit 145 determines whether or not the number of the link for transmitting the wireless frame is Link 1. The multi-link control unit 145 identifies the number of the link to be used for transmission of the wireless frame on the basis of, for example, the TID and the link management information. If it is determined in step S1103 that the number of the link for transmitting the wireless frame is Link 1, the processing proceeds to step S1104. If it is determined in step S1103 that the number of the link for transmitting the wireless frame is not Link 1, the processing proceeds to step S1107.

In step S1104, the multi-link control unit 145 increments a by 1. Thereafter, the processing proceeds to step S1105.

In step S1105, the multi-link control unit 145 determines whether or not the priority of the wireless frame to be transmitted is high on the basis of the TID, for example. For example, when the TID indicates “LL”, it is determined that the priority of the wireless frame to be transmitted is high. If it is determined in step S1105 that the priority of the wireless frame to be transmitted is high, the processing proceeds to step S1106. If it is determined in step S1105 that the priority of the wireless frame to be transmitted is not high, the processing proceeds to step S1114. Here, the determination of the priority level in step S1005 is not limited to being performed using the TID. For example, the determination of the priority level may be performed using the priority directly associated with the wireless frame to be transmitted.

In step S1106, the multi-link control unit 145 increments b by 1. Thereafter, the processing proceeds to step S1114.

In step S1107, the multi-link control unit 145 determines whether or not the number of the link for transmitting the wireless frame is Link 2. If it is determined in step S1107 that the number of the link for transmitting the wireless frame is Link 2, the processing proceeds to step S1108. If it is determined in step S1107 that the number of the link for transmitting the wireless frame is not Link 2, that is, is Link 3, the processing proceeds to step S1111.

In step S1108, the multi-link control unit 145 increments d by 1. Thereafter, the processing proceeds to step S1109.

In step S1109, the multi-link control unit 145 determines whether or not the priority of the wireless frame to be transmitted is high. The determination of the level of the priority may be performed in a manner similar to that in step S1105. If it is determined in step S1109 that the priority of the wireless frame to be transmitted is high, the processing proceeds to step S1110. If it is determined in step S1109 that the priority of the wireless frame to be transmitted is not high, the processing proceeds to step S1114.

In step S1110, the multi-link control unit 145 increments e by 1. Thereafter, the processing proceeds to step S1114.

In step S1111, the multi-link control unit 145 increments g by 1. Thereafter, the processing proceeds to step S1112.

In step S1112, the multi-link control unit 145 determines whether or not the priority of the wireless frame to be transmitted is high. The determination of the level of the priority may be performed in a manner similar to that in step S1105. If it is determined in step S1112 that the priority of the wireless frame to be transmitted is high, the processing proceeds to step S1113. If it is determined in step S1112 that the priority of the wireless frame to be transmitted is not high, the processing proceeds to step S1114.

In step S1113, the multi-link control unit 145 increments h by 1. Thereafter, the processing proceeds to step S1114.

In step S1114, the multi-link control unit 145 determines whether or not n exceeds N. N is a threshold for determining a range of the number of wireless frames used for calculation of the high priority frame rate, and is an integer of 2 or more. If it is determined in step S1114 that n does not exceed N, the processing returns to step S1102. If it is determined in step S1114 that n exceeds N, the processing proceeds to step S1115.

In step S1115, the measurement unit 144 receives a, b, d, e, g, and h from the multi-link control unit 145 and calculates each of c, f, and i. Furthermore, the measurement unit 144 calculates x and y on the basis of the calculated c, f, and i. Then, the measurement unit 144 returns x and y to the multi-link control unit 145. Here, the calculation of y may be omitted.

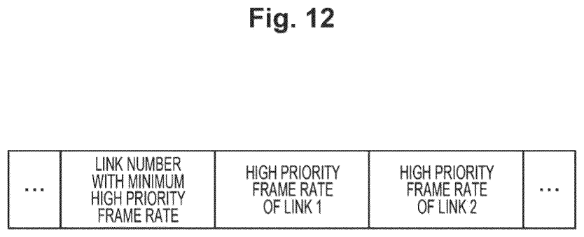

In step S1116, the multi-link control unit 145 includes the information of the link number X of the link whose high priority frame rate is the minimum value x or the information on the magnitude relationship of the high priority frame rate, that is, the value of the high priority frame rate for each link in the multi-link control information and enters the information in the beacon. Thereafter, the processing in FIG. 11 is ended. FIG. 12 is a diagram illustrating an example of entering information of a high priority frame in a beacon. In FIG. 12, both the link number with the smallest high priority frame rate and the value of the high priority frame rate for each link are entered in the beacon. It is also possible to enter only one of the link number with the smallest high priority frame rate and the value of the high priority frame rate for each link in the beacon. Furthermore, the magnitude relationship of the high priority frame rate may be a magnitude relationship of a value of the high priority frame rate for each link with respect to the average value. In this case, the average value of the high priority frame rate is further entered in the beacon illustrated in FIG. 12.

Here, in FIG. 11, n is incremented every time a transmission queue is generated. On the other hand, n does not necessarily need to be incremented every time the transmission queue is generated. For example, n may be incremented every time the transmission queue is generated five times.

In addition, the notification unit 146 may notify the traffic characteristic for each link using a beacon. The traffic characteristic for each link indicates, for example, the priority of traffic to be transmitted for each link. Specifically, the traffic characteristic for each link is information indicating that Link 1 is used for transmission of high-priority traffic such as “LL”, for example. When receiving such information of traffic characteristics for each link, the multi-link control unit 245 of the terminal 20 updates the association between the TIDs and the links.

As described above, according to the embodiment, when selecting a link for transmitting a high priority frame, the terminal 20 checks the information of the high priority frame notified from the access point 10. For example, the terminal 20 selects a link having the minimum high priority frame rate. A link having a small high priority frame rate is a link having a small occupancy rate of competing high priority traffic. Since the high priority frame is transmitted on such a link, the high priority frame to be transmitted is hardly affected by other wireless frames. Furthermore, transmission of a high priority frame on such a link is also expected to reduce the delay time.

### Modification 1

In the above-described embodiment, the terminal 20 is notified of information for link selection by the access point 10 using a beacon. Alternatively or additionally, the terminal 20 may be notified of information for link selection by the access point 10 using a trigger frame.

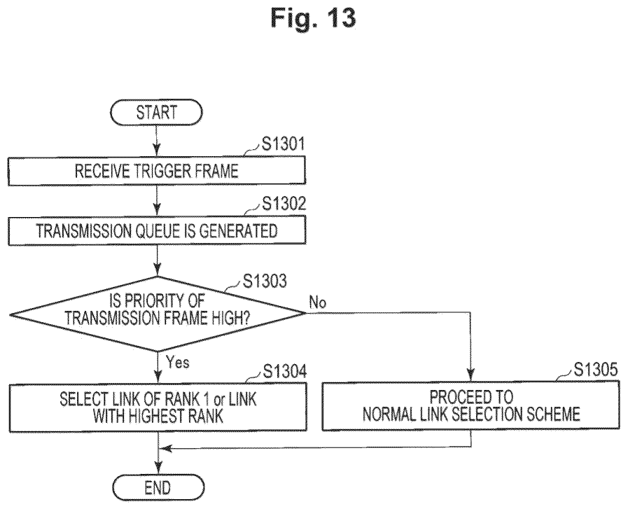

FIG. 13 is a flowchart schematically illustrating Modification 1 of the multi-link selection executed by a terminal 20. Processing of the flowchart illustrated in FIG. 13 may be started every certain period after the multi-link setup illustrated in FIG. 9 is completed.

In step S1301, a multi-link control information acquisition unit 244 receives a trigger frame from any one of wireless signal processing units 260, 270, and 280 via a MAC frame processing unit 230. When receiving the trigger frame, the multi-link control information acquisition unit 244 acquires multi-link control information from the trigger frame. The multi-link control information acquisition unit 244 sends the multi-link control information to the multi-link control unit 245.

In step S1302, each element of the terminal 20 stands by until a transmission queue is generated. When the transmission queue is generated, the processing proceeds to step S1303. Note that in a case where the transmission queue is not generated during a certain period, the processing of FIG. 13 may be ended.

In step S1303, the MAC frame processing unit 230 receives a MAC frame as a wireless frame to be transmitted via an LLC processing unit 210 and a data processing unit 220. Meanwhile, the multi-link control unit 245 determines whether or not the priority of the wireless frame to be transmitted is high on the basis of the TID, for example. If it is determined in step S1303 that the priority of the wireless frame to be transmitted is high, the processing proceeds to step S1304. If it is determined in step S1303 that the priority of the wireless frame to be transmitted is not high, the processing proceeds to step S1305. Here, the determination of the priority level in step S1303 is not limited to being performed using the TID. For example, the determination of the priority level may be performed using the priority directly associated with the wireless frame to be transmitted.

In step S1304, the multi-link control unit 245 selects a link of “Rank 1” from the ranks notified by the multi-link control information. Alternatively, the multi-link control unit 245 selects a link having the highest rank among the ranks notified by the multi-link control information. Thereafter, the processing in FIG. 13 is ended. The rank is determined in an access point 10 by the length of the delay time for each link. For example, the rank includes four ranks of Rank 1 that is the highest rank to Rank 4 that is the lowest rank, and is information included in the multi-link control information. A high rank is set for a link with a short delay time. The method of determining the rank will be described in detail later.

In step S1305, the multi-link control unit 245 selects a link on the basis of a normal link selection scheme. Thereafter, the processing in FIG. 13 is ended. For example, the multi-link control unit 245 selects a link associated with the TID.

After selecting the link, the multi-link control unit 245 notifies the MAC frame processing unit 230 of information on the selected link. The MAC frame processing unit 230 performs carrier sensing to confirm the situation of a channel corresponding to the notified link, and when the channel is idle, sends a MAC frame to the wireless signal processing unit corresponding to the notified link. As a result, the wireless signal is transmitted.

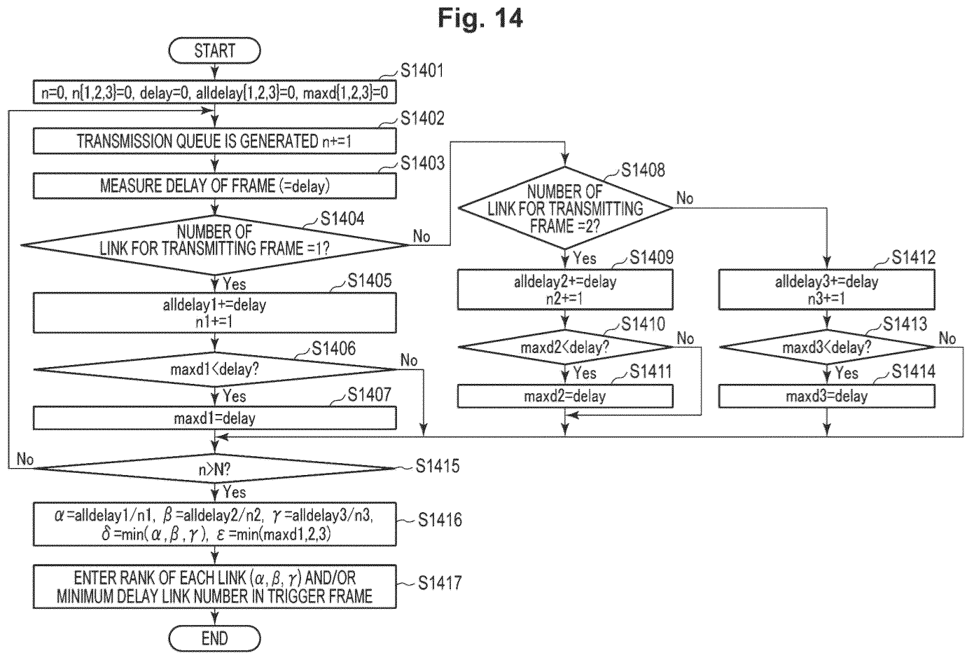

FIG. 14 is a flowchart schematically illustrating Modification 1 of the multi-link selection executed by the access point 10. Processing of the flowchart illustrated in FIG. 14 may be started every certain period after the multi-link setup illustrated in FIG. 9 is completed.

In step S1401, a multi-link control unit 145 initializes a variable for link selection. The variables include, for example, n, n {1, 2, 3}, delay, alldelay {1, 2, 3}, and maxd {1, 2, 3}. n is the count number of the total number of times of generation of a transmission queue described above. n {1, 2, 3} is a count number of the number of times of generation of transmission queues of Link 1, Link 2, and Link 3. Hereinafter, as necessary, the count number of the number of times of generation of a transmission queue of Link 1 is represented as n1, the count number of the number of times of generation of a transmission queue of Link 2 is represented as n2, and the count number of the number of times of generation of a transmission queue of Link 3 is represented as n3. delay is a delay time of transmission of the wireless frame. alldelay {1, 2, 3} is a total value of delay times of transmission of the wireless frame in Link 1, Link 2, and Link 3. Hereinafter, as necessary, the total value of the delay times of Link 1 is represented as alldelay1, the total value of the delay times of Link 2 is represented as alldelay2, and the total value of the delay times of Link 3 is represented as alldelay3. maxd {1, 2, 3} is a maximum delay time of transmission of the wireless frame in Link 1, Link 2, and Link 3. Hereinafter, as necessary, the maximum delay time of Link 1 is represented as maxd1, the maximum delay time of Link 2 is represented as maxd2, and the maximum delay time of Link 3 is represented as maxd3. In step S1401, the multi-link control unit 145 initializes n, n {1, 2, 3}, delay, alldelay {1, 2, 3}, and maxd {1, 2, 3} to 0.

In step S1402, each element of the access point 10 stands by until a transmission queue is generated. When a transmission queue is generated, the multi-link control unit 145 selects a link on the basis of, for example, a TID and link management information. Then, the multi-link control unit 145 notifies the MAC frame processing unit 130 of the information on the selected link. The MAC frame processing unit 130 performs carrier sensing to confirm the situation of a channel corresponding to the notified link, and when the channel is idle, sends a MAC frame to the wireless signal processing unit corresponding to the notified link. As a result, the wireless signal is transmitted. After completion of the wireless signal, the multi-link control unit 145 increments n by 1. Thereafter, the processing proceeds to step S1403. For example, when the wireless frame to be transmitted is a trigger frame, the trigger frame is transmitted from the access point 10 to the terminal 20. Note that the transmission of the trigger frame may be performed, for example, at each start time of a target wake time (TWT). Here, an access category with the highest priority may be assigned to the trigger frame, so that the trigger frame is sent at the start time of the TWT. Alternatively, the trigger frame may be transmitted by a priority transmission procedure different from enhanced distributed channel access (EDCA).

In step S1403, a measurement unit 144 measures the delay time delay of the transmission of the wireless frame in step S1402. As the delay time delay, for example, a time from generation of a transmission queue to completion of transmission and reception of an acknowledgment (ACK) is measured.

In step S1404, the multi-link control unit 145 determines whether or not the number of the link for transmitting the wireless frame is Link 1. If it is determined in step S1404 that the number of the link for transmitting the wireless frame is Link 1, the processing proceeds to step S1405. If it is determined in step S1404 that the number of the link for transmitting the wireless frame is not Link 1, the processing proceeds to step S1408.

In step S1405, the multi-link control unit 145 adds the delay measured in step S1403 to alldelay1. In addition, the multi-link control unit 145 increments n1 by 1. Thereafter, the processing proceeds to step S1406.

In step S1406, the multi-link control unit 145 determines whether or not delay exceeds maxd1. If it is determined in step S1406 that delay exceeds maxd1, the processing proceeds to step S1407. If it is determined in step S1406 that delay does not exceed maxd1, the processing proceeds to step S1415.

In step S1407, the multi-link control unit 145 updates maxd1 to delay. Thereafter, the processing proceeds to step S1415.

In step S1408, the multi-link control unit 145 determines whether or not the number of the link for transmitting the wireless frame is Link 2. If it is determined in step S1408 that the number of the link for transmitting the wireless frame is Link 2, the processing proceeds to step S1409. If it is determined in step S1408 that the number of the link for transmitting the wireless frame is not Link 2, that is, is Link 3, the processing proceeds to step S1412.

In step S1409, the multi-link control unit 145 adds delay measured in step S1403 to alldelay2. In addition, the multi-link control unit 145 increments n2 by 1. Thereafter, the processing proceeds to step S1410.

In step S1410, the multi-link control unit 145 determines whether or not delay exceeds maxd2. If it is determined in step S1410 that delay exceeds maxd2, the processing proceeds to step S1411. If it is determined in step S1410 that delay does not exceed maxd2, the processing proceeds to step S1415.

In step S1411, the multi-link control unit 145 updates maxd2 to delay. Thereafter, the processing proceeds to step S1415.

In step S1412, the multi-link control unit 145 adds delay measured in step S1403 to alldelay 3. In addition, the multi-link control unit 145 increments n3 by 1. Thereafter, the processing proceeds to step S1413.

In step S1413, the multi-link control unit 145 determines whether or not delay exceeds maxd3. If it is determined in step S1413 that delay exceeds maxd3, the processing proceeds to step S1414. If it is determined in step SS1413 that delay does not exceed maxd3, the processing proceeds to step S1415.

In step S1414, the multi-link control unit 145 updates maxd3 to delay. Thereafter, the processing proceeds to step S1415.

In step S1415, the multi-link control unit 145 determines whether or not n exceeds N. N is a threshold for determining a range of the number of wireless frames used for calculation of the average delay time for each link, and is an integer of 2 or more. If it is determined in step S1415 that n does not exceed N, the processing returns to step S1402. If it is determined in step S1415 that n exceeds N, the processing proceeds to step S1416.

In step S1416, the measurement unit 144 receives n {1, 2, 3} and alldelay {1, 2, 3} from the multi-link control unit 145 and calculates each of α, β, and γ. α is the average delay time in Link 1 and is calculated by α=alldelay1/n1. β is the average delay time in Link 2 and is calculated by β=alldelay2/n2. γ is the average delay time in Link 3 and is calculated by γ=alldelay3/n3. In addition, the measurement unit 144 calculates δ from α, β, and γ. δ is the minimum value of α, β, and γ, that is, the minimum value of the average delay time. Moreover, the measurement unit 144 receives maxd {1, 2, 3} from the multi-link control unit 145 and calculates ε. ε is the minimum value of maxd1, maxd2, and maxd3, that is, the minimum value of the maximum delay time. Then, the measurement unit 144 returns α, β, γ, δ, and ε to the multi-link control unit 145. Note that it is also possible to perform only one of the calculation of α, β, and γ and the calculation of δ and ε.

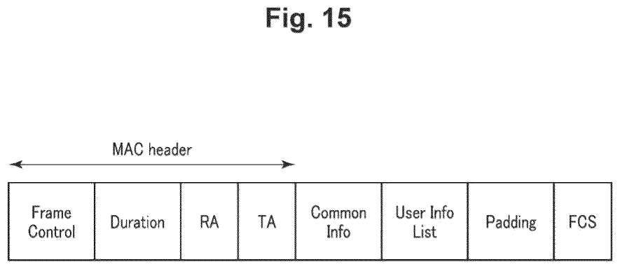

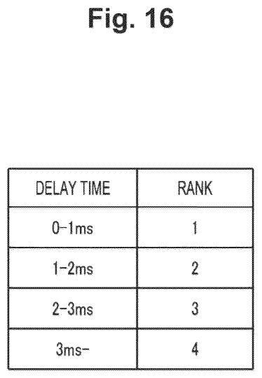

In step S1417, the multi-link control unit 145 enters, in the trigger frame, information on the rank of the average delay time for each link, and/or information on the link number of the link whose average delay time is the minimum value δ, and information on the link number whose maximum delay time is the minimum value ε. Thereafter, the processing in FIG. 14 is ended. FIG. 15 is a diagram illustrating one example of a frame format of a trigger frame. These pieces of information on delay time of the links may be entered in the Common Info field in the trigger frame. FIG. 16 is a diagram illustrating one example of a table illustrating the relationship between delay time and rank. In FIG. 16, a higher rank is set for a shorter delay time. The multi-link control unit 145 performs ranking for each link by comparing the values of α, β, and γ measured by the measurement unit 144 with the table illustrated in FIG. 16.

Here, in FIG. 14, n is incremented every time a transmission queue is generated. On the other hand, n does not necessarily need to be incremented every time the transmission queue is generated. For example, n may be incremented every time the transmission queue is generated five times.

Furthermore, in a case where a trigger frame is used, information of the high priority frame may be notified instead of the delay time. Conversely, in a case where a beacon is used, information on the delay time may be notified instead of the information on the high priority frame.

As described above, according to Modification 1, when selecting a link for transmitting a high priority frame, the terminal 20 checks the information on the delay time notified from the access point 10. For example, the terminal 20 selects a link having the minimum delay time, that is, the highest rank. By selecting the highest ranked link, it is possible to transmit the high priority frame with the shortest possible delay time. A low latency link can also be considered as a link having a small number of contention frames or a link having a small occupancy of high priority traffic. Since the high priority frame is transmitted on such a link, the high priority frame to be transmitted is hardly affected by other wireless frames.

### Modification 2

In the above-described Modification 1, the trigger frame is transmitted at each start time of the TWT. That is, in Modification 1 described above, the trigger frames are transmitted at regular intervals. On the other hand, for example, the transmission interval of the trigger frame may be dynamically changed according to the delay time.

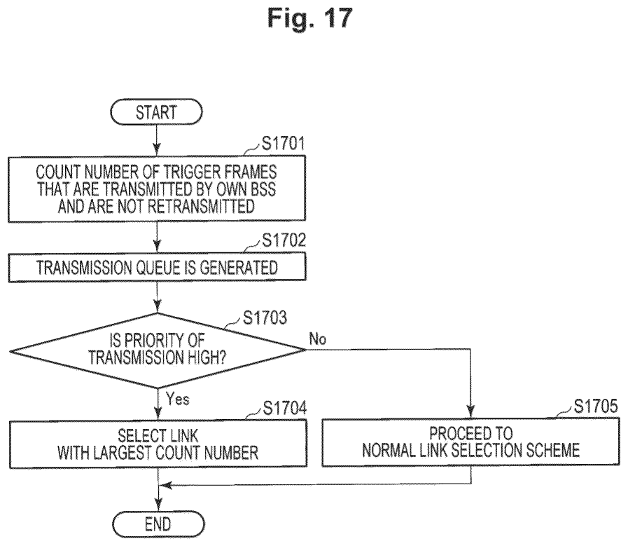

FIG. 17 is a flowchart schematically illustrating Modification 2 of the multi-link selection executed by the terminal 20. Processing of the flowchart illustrated in FIG. 17 may be started every certain period after the multi-link setup illustrated in FIG. 9 is completed.

In step S1701, the multi-link control unit 245 counts the number of trigger frames that are transmitted in a basic service set (BSS) to which its own terminal belongs and are not retransmitted for each link.

In step S1702, each element of a terminal 20 stands by until a transmission queue is generated. When the transmission queue is generated, the processing proceeds to step S1703. Note that in a case where the transmission queue is not generated during a certain period, the processing of FIG. 17 may be ended.

In step S1703, a MAC frame processing unit 230 receives a MAC frame as a wireless frame to be transmitted via an LLC processing unit 210 and a data processing unit 220. Meanwhile, the multi-link control unit 245 determines whether or not the priority of the wireless frame to be transmitted is high on the basis of the TID, for example. If it is determined in step S1703 that the priority of the wireless frame to be transmitted is high, the processing proceeds to step S1704. If it is determined in step S1703 that the priority of the wireless frame to be transmitted is not high, the processing proceeds to step S1705. Here, the determination of the priority level in step S1703 is not limited to being performed using the TID. For example, the determination of the priority level may be performed using the priority directly associated with the wireless frame to be transmitted.

In step S1704, the multi-link control unit 245 selects a link having the largest count number of the trigger frame. Thereafter, the processing in FIG. 17 is ended.

After selecting the link, the multi-link control unit 245 notifies the MAC frame processing unit 230 of information on the selected link. The MAC frame processing unit 230 performs carrier sensing to confirm the situation of a channel corresponding to the notified link, and when the channel is idle, sends a MAC frame to the wireless signal processing unit corresponding to the notified link. As a result, the wireless signal is transmitted.

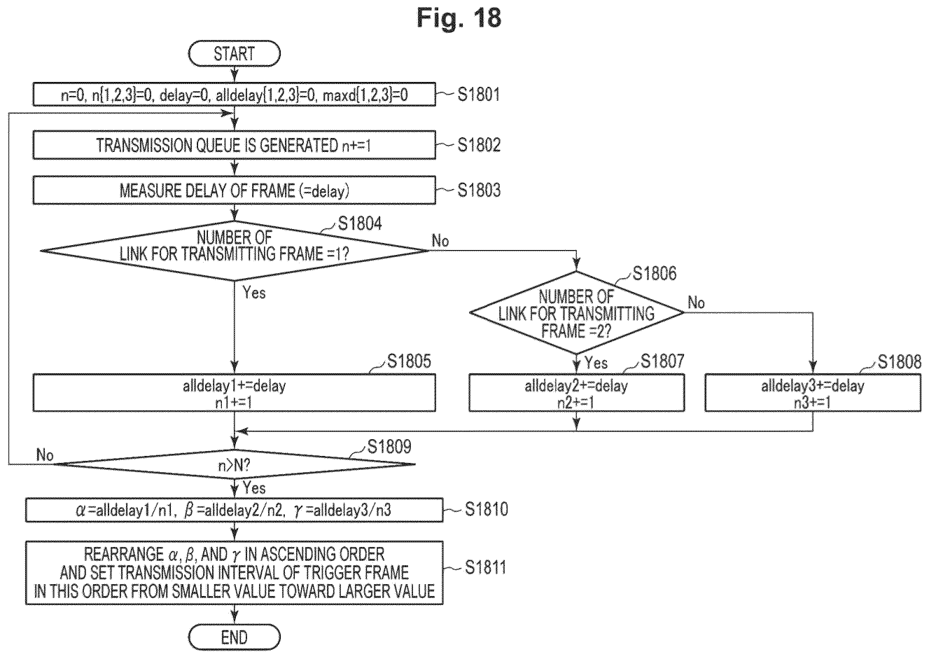

FIG. 18 is a flowchart schematically illustrating Modification 2 of the multi-link selection executed by an access point 10. Processing of the flowchart illustrated in FIG. 18 may be started every certain period after the multi-link setup illustrated in FIG. 9 is completed.

In step S1801, a multi-link control unit 145 initializes a variable for link selection. The variables include, for example, n, n {1, 2, 3}, delay, alldelay {1, 2, 3}, and maxd {1, 2, 3}. These variables are the same as those described in FIG. 14.

In step S1802, each element of the access point 10 stands by until a transmission queue is generated. When a transmission queue is generated, the multi-link control unit 145 selects a link on the basis of, for example, a TID and link management information. Then, the multi-link control unit 145 notifies the MAC frame processing unit 130 of the information on the selected link. The MAC frame processing unit 130 performs carrier sensing to confirm the situation of a channel corresponding to the notified link, and when the channel is idle, sends a MAC frame to the wireless signal processing unit corresponding to the notified link. As a result, the wireless signal is transmitted. After completion of the wireless signal, the multi-link control unit 145 increments n by 1. Thereafter, the processing proceeds to step S1803. For example, when the wireless frame to be transmitted is a trigger frame, the trigger frame is transmitted from the access point 10 to the terminal 20. Note that the transmission of the trigger frame may be performed according to an interval to be described later. Here, as in Modification 1, an access category with the highest priority may be assigned to the trigger frame. Alternatively, the trigger frame may be transmitted by a priority transmission procedure different from EDCA. Note that in a case where the transmission queue is not generated during a certain period, the processing of FIG. 18 may be ended.

In step S1803, a measurement unit 144 measures the delay time delay of the transmission of the wireless frame in step S1802.

In step S1804, the multi-link control unit 145 determines whether or not the number of the link for transmitting the wireless frame is Link 1. If it is determined in step S1804 that the number of the link for transmitting the wireless frame is Link 1, the processing proceeds to step S1805. If it is determined in step S1804 that the number of the link for transmitting the wireless frame is not Link 1, the processing proceeds to step S1808.

In step S1805, the multi-link control unit 145 adds delay measured in step S1803 to alldelay1. In addition, the multi-link control unit 145 increments n1 by 1. Thereafter, the processing proceeds to step S1809.

In step S1806, the multi-link control unit 145 determines whether or not the number of the link for transmitting the wireless frame is Link 2. If it is determined in step S1806 that the number of the link for transmitting the wireless frame is Link 2, the processing proceeds to step S1807. If it is determined in step S1806 that the number of the link for transmitting the wireless frame is not Link 2, that is, is Link 3, the processing proceeds to step S1808.

In step S1807, the multi-link control unit 145 adds delay measured in step S1803 to alldelay 2. In addition, the multi-link control unit 145 increments n2 by 1. Thereafter, the processing proceeds to step S1809.

In step S1808, the multi-link control unit 145 adds delay measured in step S1803 to alldelay 3. In addition, the multi-link control unit 145 increments n3 by 1. Thereafter, the processing proceeds to step S1809.

In step S1809, the multi-link control unit 145 determines whether or not n exceeds N. N is a threshold for determining a range of the number of wireless frames used for calculation of the average delay time for each link, and is an integer of 2 or more. If it is determined in step S1809 that n does not exceed N, the processing returns to step S1802. If it is determined in step S1809 that n exceeds N, the processing proceeds to step S1810.

In step S1810, the measurement unit 144 receives n {1, 2, 3} and alldelay {1, 2, 3} from the multi-link control unit 145 and calculates each of α, β, and γ. Then, the measurement unit 144 returns α, β, and γ to a notification unit 146. α, β, and γ are average delay times in the links described above.

In step S1811, the multi-link control unit 145 rearranges the average delay times α, β, and γ in ascending order. Then, the multi-link control unit 145 sets the transmission interval of the trigger frame to a smaller value in ascending order of the average delay time. For example, when the delay time is shorter in the order of α, β, and γ, the transmission interval of the trigger frame is set to be shorter in the order of α, β, and γ. For example, the transmission interval of β may be set to a predetermined median value (for example, TWT interval), the transmission interval of α may be set to be shorter than the transmission interval of β by a certain time, and the transmission interval of γ may be set to be longer than the transmission interval of β by a certain time.

Here, in FIG. 18, n is incremented every time a transmission queue is generated. On the other hand, n does not necessarily need to be incremented every time the transmission queue is generated. For example, n may be incremented every time the transmission queue is generated five times.

In addition, the method of shortening the transmission interval of the trigger frame is not limited to changing the setting value of the transmission interval. For example, the transmission interval of the trigger frame is shortened by performing transmission of a dummy trigger frame in addition to the normal transmission of the trigger frame.

As described above, according to Modification 2, the transmission interval of the trigger frame for each link is set according to the delay time for each link. That is, the transmission interval of the trigger frame reflects the information of the delay time for each link. Therefore, the terminal 20 can grasp the magnitude of the delay time for each link only by observing the transmission interval of the trigger frame. As a result, the terminal 20 can select a link suitable for transmitting a high priority frame.

Here, in Modification 2, the transmission interval of the trigger frame is set according to the delay time. On the other hand, the transmission interval of the trigger frame may be set according to the high priority frame rate.

In addition, in the above-described embodiment and the modifications thereof, the wireless communication function included in the wireless station (the access point 10 and the terminal 20) may be implemented by an individual component such as a chip. For example, a chip may be incorporated into a substrate of the wireless station at the time of manufacturing the wireless station. A wireless device mentioned herein may refer to a wireless station, or may refer to an individual component that implements the wireless communication function of the wireless station.

Note that the present invention is not limited to the above embodiment and various modifications may be made in the implementation stage without departing from the gist of the invention. The embodiments may be implemented in appropriate combinations, and combined advantageous effects can be obtained in these cases. Further, the above embodiment includes various inventions, and various inventions can be extracted by combinations selected from a plurality of disclosed constituent elements. For example, in a case where the problem can be solved and the effects can be obtained even if some constituent elements are deleted from all the constituent elements described in the embodiment, a configuration from which the constituent elements are deleted can be extracted as an invention.

### REFERENCE SIGNS LIST

10 Access point
20 Terminal
30 Server
40 Communication network
45 Wireless network
50 Communication system
101 CPU
102 Program memory
103 RAM
104 Wireless communication module
105 Wired communication module
110 LLC processing unit
120 Data processing unit
130 MAC frame processing unit
131 Classification unit
132A, 132B, 132C, 132D, 132E Transmission queue
133A, 133B, 133C, 133D, 133E Carrier sensing execution unit
134 Collision management unit
140 Management unit
141 Link management information
142 Association processing unit
143 Authentication processing unit
144 Measurement unit
145 Multi-link control unit
146 Notification unit
150 Link management unit
160, 170, 180 Wireless signal processing unit
201 CPU
202 Program memory
203 RAM
204 Wireless communication module
205 Display
206 Storage
210 LLC processing unit
220 Data processing unit
230 MAC frame processing unit
240 Management unit
241 Link management information
242 Association processing unit
243 Authentication processing unit
244 Multi-link control information acquisition unit
245 Multi-link control unit
250 Link management unit
260, 270, 280 Wireless signal processing unit
290 Application execution unit

1. A wireless apparatus comprising a processor configured to:
acquire an index contributing to selection of a link for transmitting a high priority frame among a plurality of links forming multiple links with another wireless apparatus; and
notify the another wireless apparatus of information for selection of the link on the basis of the index.

2. The wireless apparatus according to claim 1, wherein
the index includes at least one of a high priority frame rate indicating an occupancy of a high priority frame in a wireless frame transmitted in each link, and a delay time of transmission of a wireless frame in each link.

3. The wireless apparatus according to claim 2, wherein
the processor notifies the another wireless apparatus of information of a link having a minimum high priority frame rate or information of a link having a minimum delay time as information for selection of the link.

4. The wireless apparatus according to claim 1, wherein
the processor includes information for selection of the link in a beacon and notifies the other wireless apparatus of the information.

5. The wireless apparatus according to claim 1, wherein
the processor includes information for selection of the link in a trigger frame and notifies the another wireless apparatus of the information.

6. The wireless apparatus according to claim 5, wherein
the index includes at least one of a high priority frame rate indicating an occupancy of a high priority frame in a wireless frame transmitted in each link and a delay time of transmission of a wireless frame in each link, and
the processor sets a transmission interval of the trigger frame according to a size of the high priority frame or the delay time.
